(19) United States
(12) Patent Application Publication
(10) Pub. No.: US 2026/0284695 A1
(43) Pub. Date: Sep. 24, 2026

(54) Wall Surface-Temperature-Controlled Thin-Film Coaters (Slot-Die Head)

(71) Applicant: Northwestern University, Evanston, IL (US)

(72) Inventors: Qian Wang, Evanston, IL (US); Jian Cao, Wilmette, IL (US); Jeffrey Lopez, Evanston, IL (US); Jeffrey John Richards, Evanston, IL (US); Henry Soewardiman, Evanston, IL (US)

(73) Assignee: Northwestern University, Evanston, IL (US)

(21) Appl. No.: 19/574,746

(22) Filed: Mar. 23, 2026

Related U.S. Application Data
(60) Provisional application No. 63/776,736, filed on Mar. 24, 2025.

(51) Int. Cl. B05C 5/02; B05C 11/10; B05D 1/26

(52) U.S. Cl. CPC B05C 5/0254; B05C 11/1015; B05D 1/26

(57) ABSTRACT

A slot-die coating system may include a slot-die head having a channel defined by a first wall and a second wall, the channel configured to receive a fluid material at an inlet and discharge the fluid material at an outlet. A temperature control system may be configured to maintain the first wall at a first temperature and the second wall at a second temperature different from the first temperature creating a temperature differential between the first wall and the second wall that may induce a viscosity differential in the boundary layers of the fluid material adjacent to the first wall and the second wall. A coating bed may be positioned to receive the fluid material discharged from the outlet of the channel.

### CROSS-REFERENCE TO RELATED APPLICATIONS

This application claims priority to U.S. Provisional Patent Application No. 63/776,736 filed on Mar. 24, 2025, and is incorporated by reference in its entirety for all non-limiting purposes.

### FIELD OF INVENTION

The present disclosure relates to thin-film coating systems and slot-die coaters, and more particularly, to wall surface temperature control within a slot-die channel to modify fluid boundary-layer viscosity and flow characteristics for improved coating deposition.

### BACKGROUND

Slot-die coating is a method for depositing thin films of fluid materials onto substrates. In slot-die coating systems, a fluid material is fed through a channel within a slot-die head and exits through a narrow slot onto a moving substrate or bed. The characteristics of the fluid flow within the channel may affect the quality and uniformity of the resulting coating.

Fluid viscosity plays a significant role in determining fluid flow behavior within the slot-die channel. Viscosity is a function of temperature, with higher temperatures generally resulting in lower viscosity values for many fluid materials. In conventional slot-die coaters, wall temperatures within the channel are typically uniform or uncontrolled, which may limit the ability to tailor fluid flow characteristics for specific coating applications.

Under conventional operating conditions in which the walls of the slot-die are maintained at substantially uniform temperatures, fluid flow within the slot channel generally exhibits a Poiseuille-type velocity profile. Such flow profiles may produce non-uniform shear rate distributions across the channel gap, with relatively high shear rates near the channel walls and lower shear rates toward the center of the channel. For certain coating fluids, these shear gradients may contribute to flow instabilities near the die exit which can negatively affect coating uniformity in some applications.

There is a need for improved control over fluid flow characteristics within slot-die channels. In particular, the methods and systems disclosed herein may achieve either more uniform shear rates across the channel or certain designed flow patterns with preferred shear rate distribution, thus to provide better control over coating deposition with desired flexibility, which would be beneficial for various thin-film coating applications. Certain changes of the field profiles of flow velocity and viscosity can also create certain actions of the fluid to adjust its composition uniformity and properties.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Aspects of the present disclosure are directed to slot-die coating systems and alike that may include a slot-die head having a channel defined by a first wall and a second wall, the channel may be configured to receive a fluid material at an inlet and discharge the fluid material at an outlet. The system may also include a temperature control system configured to maintain the first wall at a first temperature and the second wall at a second temperature different from the first temperature that may create a temperature differential between the first wall and the second wall or a first temperature rate variation along the first wall differs from a second temperature rate variation along the second wall that may induce a viscosity differential in boundary layers of the fluid material adjacent to the first wall and the second wall, and a coating bed may be positioned to receive the fluid material discharged from the outlet of the channel. In one example, the first temperature may be higher than the second temperature and the higher first temperature may induce a lower viscosity in the boundary layer of the fluid material adjacent to the first wall relative to the boundary layer adjacent to the second wall. In other examples, the lower viscosity in the boundary layer adjacent to the first wall may induce a slip of the fluid material along the first wall, resulting in acceleration of fluid flow along the first wall relative to fluid outside of a thermal boundary layer. In another example, the slip may transform a flow field of the fluid material from a Poiseuille-type flow profile to a Maxwell-type flow profile, or even Couette-type flow profile, reducing a change in shear rate across the channel.

In certain examples, the first temperature and the second temperature may each be constant along a height of the channel from the inlet to the outlet. In other examples, the temperature control system may be configured to vary the first temperature as a function of position along a height of the channel from the inlet to the outlet. In still other examples, the temperature control system may be configured to vary the second temperature as a function of position along the height of the channel, and the first temperature and the second temperature may vary at a same gradient or at different gradients along the height of the channel. In yet another example, the first temperature and the second temperature may be within a range of 20° C. to 300° C. for fluid materials comprising polymers or polymer-based materials. In another example, the first temperature and the second temperature may be within a range of 20° C. to 500° C. for fluid materials comprising metal-based materials. In one example, the coating bed may be configured to move at a layering velocity relative to the slot-die head, and the coating bed may hold substrates such as metals, plastics, fuel cell membranes, or textiles. In another example, the system may include a feedback control system that may be configured to adjust the first temperature and the second temperature based on quality control or process control parameters.

Aspects of the present disclosure are also directed to methods for depositing thin-film coatings on a substrate that may include the steps of feeding a fluid material into a channel of a slot-die head in which the channel may include a first wall and a second wall, controlling a surface temperature the first wall and/or the second wall to create a temperature variation along a height of the channel in which the temperature variation may induce a change in viscosity of a boundary layer of the fluid material adjacent to the first wall and/or the second wall, and discharging the fluid material from an outlet of the channel onto a substrate.

In some examples, controlling the surface temperature may include maintaining the first wall at a first temperature higher than a second temperature of the second wall in which the higher first temperature may induce a lower viscosity in the boundary layer adjacent to the first wall that may cause a slip of the fluid material along the first wall. In other examples, the slip may transform a flow field of the fluid material from a Poiseuille-type flow profile to a Couette-type flow profile that may provide a more spatially uniform shear rate within the channel. In another example, the temperature variation may include a linear temperature gradient along the height of the channel from an inlet to the outlet. In still other examples, the fluid material may include a slurry containing polyvinylidene fluoride, polytetrafluoroethylene, styrene-butadiene rubber, chitosan, lignin, polyacrylic acid, sodium alginate, or carboxymethyl cellulose.

Aspects of the present disclosure are also directed to a slot-die head for thin-film coating may include a first channel plate having a first inner surface, a second channel plate having a second inner surface in which the first inner surface and the second inner surface defining a channel therebetween for fluid flow, and a heating element may be configured to heat the first inner surface and/or the second inner surface to a temperature higher than a temperature of a fluid material within the channel in which the first inner surface and/or the second inner surface may reduce a viscosity of a boundary layer of the fluid material adjacent to the channel inner surface(s).

In certain examples, the heating element may be configured to heat the first inner surface to a first temperature and the second inner surface to a second temperature different from the first temperature that creates an asymmetric temperature distribution across the channel. In another example, the reduced viscosity of the boundary layer adjacent to the first inner surface and/or the second inner surface may induce a slip of the fluid material that cause flow profile to change. In some examples, the heating element may be configured to vary a temperature of the first inner surface and/or the second inner surface as a function of position along a height of the channel from an inlet to an outlet of the channel.

The foregoing general description of the illustrative embodiments and the following detailed description thereof are merely exemplary aspects of the teachings of this disclosure and are not restrictive.

### BRIEF DESCRIPTION OF FIGURES

The patent or application file contains at least one drawing executed in color. Copies of this patent or patent application publication with color drawing(s) will be provided by the Office upon request and payment of the necessary fee. The foregoing and other features and advantages of the present embodiments will be more fully understood from the following detailed description of illustrative embodiments taken in conjunction with the accompanying drawings in which non-limiting and non-exhaustive examples are described with reference to the following figures.

FIG. 1 depicts a graph illustrating a relationship between viscosity and temperature for a fluid material, according to aspects of the present disclosure.

FIG. 2 depicts a schematic cross-sectional diagram of a slot-die coater channel with fluid flow parameters and boundary conditions, according to aspects of the present disclosure.

FIG. 3 depicts a schematic cross-sectional diagram of a slot-die head channel illustrating fluid flow and left and right wall surfaces having constant but different temperatures, according to aspects of the present disclosure.

FIG. 4A depicts a graph showing velocity cross-section profiles comparing symmetric and asymmetric wall temperature conditions, according to aspects of the present disclosure.

FIG. 4B depicts a graph showing temperature cross-section data comparing asymmetric and symmetric wall temperature conditions, according to aspects of the present disclosure.

FIG. 5 depicts a schematic diagram illustrating gradient wall temperatures and the related fluid dynamics within a slot-die channel, according to aspects of the present disclosure.

FIG. 6 depicts a schematic diagram of a slot-die channel with linearly varying wall temperatures and corresponding fluid flow characteristics, according to aspects of the present disclosure.

FIG. 7A depicts a graph showing cross-sectional temperature profiles under constant wall temperature conditions, according to aspects of the present disclosure.

FIG. 7B depicts a graph showing cross-sectional temperature profiles under variable wall temperature conditions shown in FIG. 6, according to aspects of the present disclosure.

FIG. 8 depicts a graph comparing velocity cross-section profiles for fixed and variable wall temperature conditions, according to aspects of the present disclosure.

FIG. 9A depicts a graph showing cross-sectional temperature profiles under constant wall temperature conditions, according to aspects of the present disclosure.

FIG. 9B depicts a graph showing cross-sectional temperature profiles under variable wall temperature conditions shown in FIG. 6, according to aspects of the present disclosure.

FIG. 10A depicts a graph showing molecular viscosity profiles under constant wall temperature conditions, according to aspects of the present disclosure.

FIG. 10B depicts a graph showing molecular viscosity profiles under variable wall temperature conditions shown in FIG. 6, according to aspects of the present disclosure.

FIG. 11 depicts a diagram illustrating various wall temperature schemes for flow velocity asymmetry control, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to slot-die coating systems and methods that employ controlled wall surface temperatures to modify fluid flow characteristics within a slot-die channel. Slot-die coating involves feeding a fluid material through a channel defined by opposing walls and depositing the fluid material onto a moving substrate to form a thin-film coating. The quality and uniformity of the resulting coating depend on the flow behavior of the fluid material as the fluid material passes through the channel and exits onto the substrate.

Viscosity of a fluid material exhibits a strong dependence on temperature. As temperature increases, viscosity decreases, and as temperature decreases, viscosity increases. This temperature-viscosity relationship provides a mechanism for controlling fluid flow behavior within a slot-die channel by manipulating the temperature of the channel walls. When a wall surface is maintained at a temperature different from the bulk temperature of the fluid material, a thermal boundary layer forms adjacent to the wall surface. Within this thermal boundary layer, the fluid material assumes a temperature approaching that of the wall surface, resulting in a corresponding change in viscosity. Accordingly, when a wall surface is heated to a temperature higher than the bulk fluid temperature, the boundary layer adjacent to that wall surface exhibits a reduced viscosity compared to the bulk fluid. This reduced viscosity in the boundary layer induces an apparent “slip” of the fluid material along the heated wall surface. The slip results from acceleration of the fluid flow along the wall relative to fluid outside of the thermal boundary layer. For Newtonian fluids, this phenomenon may transform the flow field profile from a Poiseuille-type flow profile toward a Maxwell-type flow profile, or even Couette-type flow profile, reducing the change in shear rate across the channel width, or modifying the profile as desired to control the flow field variations. For Newtonian fluids, flow profile changes are also expected. Certain changes of the field profiles of flow velocity and viscosity can also create certain actions of the fluid to adjust its composition uniformity and properties.

The transformation of the flow profile provides advantages for thin-film coating applications. A more spatially uniform shear rate within the channel promotes consistent processing of the fluid material as the fluid material travels through the channel. Additionally, the acceleration of fluid flow near the heated wall surface reduces the potential for recirculation at the channel exit as the fluid material encounters the moving boundary of the substrate. Reduced recirculation contributes to improved coating uniformity and quality.

Wall surface temperature control may be implemented in various configurations. In some examples, one wall may be maintained at a constant temperature higher than the other wall, creating an asymmetric temperature distribution across the channel. In some examples, wall surface temperature may vary as a function of position along the height of the channel from an inlet to an outlet. The temperature variation along the channel height causes the boundary-layer viscosity to change as the fluid material flows through the channel, resulting in flow velocity profiles that evolve along the channel length. Different temperature schemes produce different flow velocity and stress fields, which influence the ordering of fluid components and the characteristics of the deposited coating.

The slot-die coating systems and methods described herein may be applied to a variety of fluid materials, including slurries containing particles of functional materials, polymer-based compositions, polymer melts, solutions of small molecules or oligomers, and liquid metal-based compositions. Applications include thin-film coatings for lithium-ion battery electrodes and electrolytes, coatings for other battery types, coatings for sensors, fuel cells, electrolyzers, and other electrochemical devices, polymer films and membranes, and metal coatings. The substrate onto which the coating is deposited may include metals such as copper and aluminum, plastics such as polyethylene terephthalate, fuel cell membranes, textiles, or removable sheets for producing free-standing thin films.

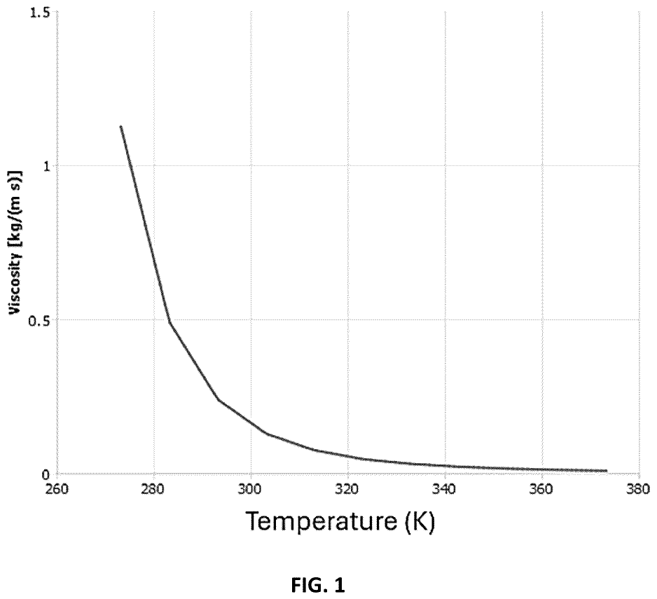

Referring to FIG. 1, the graph illustrates the relationship between viscosity and temperature for a fluid material. FIG. 1 uses motor oil as the example fluid material to illustrate the temperature-viscosity relationship. The vertical axis represents viscosity of a material and the horizontal axis represents static temperature of the material. The graph displays a curve demonstrating that viscosity decreases as temperature increases. At lower temperatures near 275° K, the viscosity is about 1 kg/(m·s). The curve exhibits a steep decline as temperature increases through the range of 280° K to 320° K. As the temperature continues to increase beyond 320° K, the viscosity approaches values near zero and the curve flattens. The data shown in FIG. 1 demonstrates that viscosity is a strong function of temperature, with higher temperatures resulting in lower viscosity values. This temperature-dependent viscosity behavior provides the physical basis for controlling fluid flow characteristics within a slot-die channel through manipulation of wall surface temperatures. When a wall surface is maintained at an elevated temperature, the fluid material in the boundary layer adjacent to that wall surface may experience a corresponding reduction in viscosity.

The temperature variation along the wall surfaces of a slot-die channel may be accomplished with any means to achieve a desired wall surface temperature profile. Heating elements, cooling elements, heat exchangers, resistive heaters, fluid circulation systems, thermoelectric devices, or combinations thereof may be employed to establish and maintain the desired temperature distribution along the channel walls. The selection of temperature control means may depend on factors such as the temperature range, the spatial resolution of temperature control, the thermal properties of the channel wall materials, and the processing requirements of the fluid material being coated.

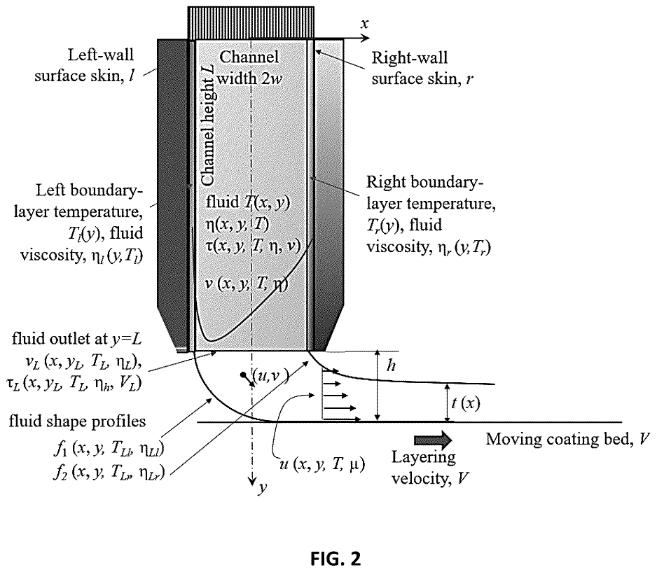

FIG. 2 illustrates a schematic cross-sectional diagram of a slot-die coater channel structure with associated fluid flow parameters and boundary conditions. The slot-die channel has a width annotated as 2 w and a depth (or height) annotated as L, with a flow exit height annotated as h at the channel outlet. A left-wall surface skin is designated as l, and a right-wall surface skin is designated as r. Fluid material enters the channel at an inlet positioned at the top of the channel. The fluid material entering the channel may have a composition M, properties C, a pressure pₒ, and a temperature Tₒ. As the fluid material flows through the channel, the fluid material interacts with the wall surfaces and experiences thermal and viscous effects that influence the flow behavior. The left-wall surface temperature, depicted in red, is controlled as a function of vertical position along the channel height, expressed as Tₗ(y). Similarly, the right-wall surface temperature, depicted in blue, is controlled as a function of vertical position, expressed as Tᵣ(y). The wall surface temperatures establish boundary conditions for the thermal field within the channel. The fluid material in the boundary layers adjacent to the wall surfaces assumes temperatures approaching the respective wall surface temperatures.

As also shown in FIG. 2, the boundary-layer viscosities depend on both the vertical position and the local wall temperature. The left boundary-layer viscosity is expressed as ηₗ(y, Tₗ), indicating that the viscosity in the boundary layer adjacent to the left wall is a function of the vertical position y and the left-wall temperature Tₗ. The right boundary-layer viscosity is expressed as ηᵣ(y, Tᵣ), indicating that the viscosity in the boundary layer adjacent to the right wall is a function of the vertical position y and the right-wall temperature Tᵣ. As previously discussed, because viscosity exhibits a strong dependence on temperature, the boundary-layer viscosities vary along the channel height in accordance with the wall temperature profiles. Within the channel, the fluid temperature is affected by the boundary temperatures and varies as a function of both horizontal position and vertical position, expressed as T(x, y). The energy equation governing the temperature field satisfies the boundary conditions T(x=−w, y)=Tₗ(y) at the left wall and T(x=w, y)=Tᵣ(y) at the right wall. The fluid viscosity within the channel is a function of position and temperature, expressed as η(x, y, T), with boundary values η(x=−w, y, T)=ηₗ(y, Tₗ) at the left wall and η(x=w, y, T)=ηᵣ(y, Tᵣ) at the right wall. The flow velocity profile is a function of position, temperature, and viscosity, expressed as v(x, y, T, η). The stress in the fluid material is a function of velocity expressed as τ(x, y, T, η, v). Control of the wall surface temperatures thereby controls the motion and stress field of the fluid flow within the channel. At the channel outlet where y equals L, outlet parameters including outlet velocity v_{L}, shear stress τ_{L}, temperature T_{L}, and viscosity η_{L} and characterize the fluid material and shape profiles as the fluid material exits the channel. Fluid shape profiles f₁ and f₂ at the left and right boundaries, respectively, are functions of position, temperature, and viscosity, characterizing the fluid material geometry at the channel exit region. The fluid material discharged from the channel outlet flows onto a coating bed that moves at a layering velocity V in a horizontal direction. The coating bed may hold a substrate onto which the fluid material is deposited. A coating thickness t(x) is formed on the substrate as the fluid material is deposited. The exit flow profiles, determined by the wall temperature control and the resulting velocity and stress fields, influence the coating thickness and coating quality.

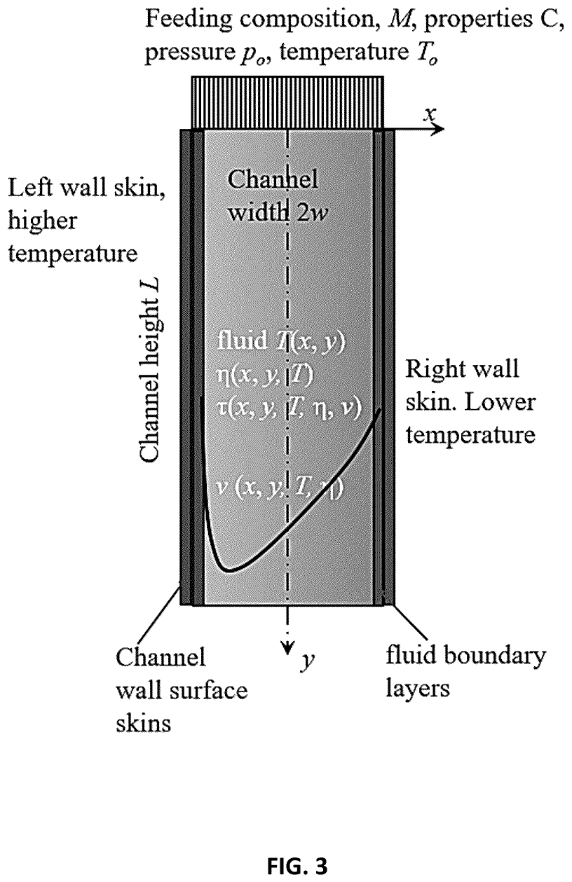

FIG. 3 illustrates a schematic cross-sectional diagram of a slot-die head channel configuration where wall surface temperatures are constant, but different between the left and right walls. The channel has a width of 2 w and a channel height L, and a feeding composition M with properties C, pressure pₒ, and temperature Tₒ enters from the top of the channel through an inlet region. The coater is so illustrated; actually, its orientation can be any. In this configuration, the left wall skin is maintained at a higher constant temperature, as indicated by the red coloring along the left side of the channel. The right wall skin is maintained at a lower constant temperature, as indicated by the blue coloring along the right side of the channel. The temperature differential between the left wall and the right wall creates an asymmetric thermal environment within the channel. The fluid material within the channel exhibits a temperature distribution T(x, y) that varies spatially between the two walls. The temperature distribution transitions from warmer near the left wall to cooler near the right wall, as shown by the color gradient from red to blue across the channel width. The fluid viscosity η(x, y, T), shear stress τ(x, y, T, η, v), and velocity v(x, y, T, η) are functions of position and temperature within the channel. The higher temperature at the left wall causes the boundary layer of the fluid material adjacent to the left wall to exhibit a lower viscosity compared to the boundary layer adjacent to the right wall. This lower viscosity in the left boundary layer induces a slip of the fluid material along the left wall surface. The slip results in acceleration of the fluid flow along the left wall relative to fluid outside of the thermal boundary layer. A velocity profile curve near the bottom of the channel illustrates the slip and asymmetric flow distribution resulting from the temperature differential between the walls. The asymmetric velocity profile differs from a symmetric Poiseuille-type profile that would result from uniform wall temperatures. The transformation toward an asymmetric flow profile reduces the change in shear rate across the channel width, providing a more spatially uniform shear rate within the channel. Fluid boundary layers form adjacent to both the left and right channel wall surface skins, where the local viscosity is influenced by the respective wall temperatures.

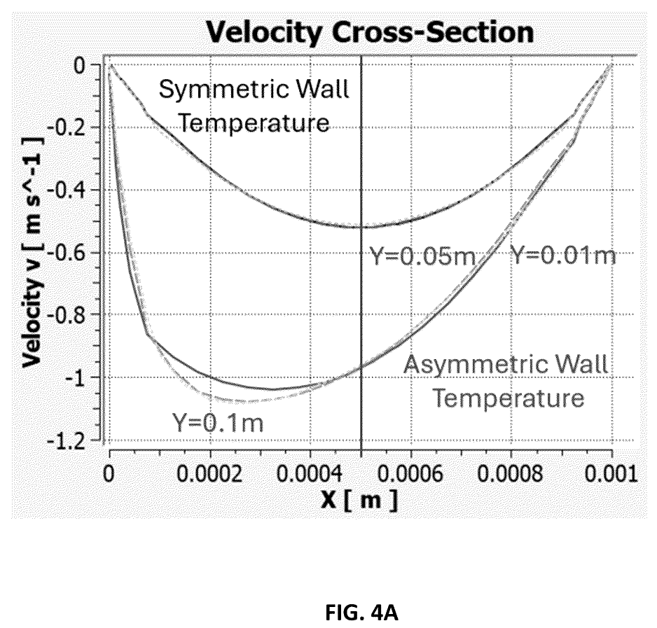

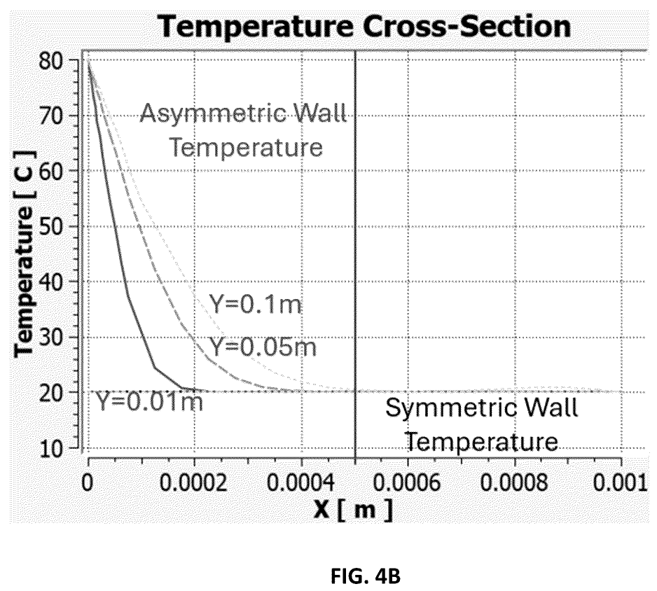

FIG. 4A graphically depicts velocity cross-section profiles comparing symmetric wall temperature conditions with asymmetric wall temperature conditions. The horizontal axis represents the position X measured in meters and the vertical axis represents velocity v measured in meters per second. The graph displays multiple curves corresponding to different vertical positions within the channel, specifically at Y equals 0.1 meters, Y equals 0.05 meters, and Y equals 0.01 meters. A vertical reference line indicates the channel centerline located at approximately X equals 0.0005 meters. The symmetric wall temperature curves appear as the black and grey lines near the top of the graph, showing profiles that are symmetric about the channel centerline. The dashed and solid lines show profiles at different channel locations indicated by Y=0.01, 0.05, 0.1 to the top entrance; they are overlapped because the velocity profiles are the same. Under symmetric wall temperature conditions where both walls are maintained at 20° C., the velocity profiles exhibit peak velocities of approximately −0.52 m/s. The symmetric profiles demonstrate the characteristic Poiseuille-type flow behavior associated with uniform thermal boundary conditions across the channel width. The asymmetric wall temperature curves appear as the red-pink lines positioned lower in the graph, displaying velocity profiles and exhibiting asymmetry across the channel width. When the left wall is maintained at 80° C. and the right wall is maintained at 20° C., the asymmetric temperature condition produces velocity profiles with peak velocities occurring closer to the left wall and approaching −1.1 m/s. The velocity profiles under asymmetric wall temperature conditions demonstrate relatively consistent shapes across the different vertical positions, indicating that the constant but different wall temperatures produce similar flow characteristics along the channel height. The difference between the symmetric and asymmetric velocity profiles illustrates the effect of wall surface temperature control on fluid flow behavior. The higher temperature at the left wall reduces the viscosity in the boundary layer adjacent to the left wall, inducing a slip that accelerates the fluid flow along the left wall surface. Again, this acceleration shifts the peak velocity location toward the heated wall and increases the overall flow velocity magnitude compared to the symmetric temperature case.

FIG. 4B graphically depicts temperature cross-section data comparing asymmetric wall temperature conditions with symmetric wall temperature conditions. Here, the vertical axis represents temperature in degrees Celsius, ranging from 10° C. to 80° C. Three curves are shown for the asymmetric wall temperature example, corresponding to different Y positions of 0.01 m, 0.05 m, and 0.1 m. The curves demonstrate a steep temperature decrease near the left wall boundary, starting from approximately 75° C.-80°C. at X equals 0, and rapidly declining to approximately 20° C. as X increases toward the channel center. The steep temperature gradient near the left wall indicates the development of a thermal boundary layer from the heated wall surface. A horizontal dashed line at approximately 20° C. represents the symmetric wall temperature condition, which remains constant across the channel width. Under symmetric wall temperature conditions, the fluid temperature remains uniform throughout the channel cross-section. In contrast, the asymmetric wall temperature conditions create a thermal boundary layer adjacent to the heated left wall where the fluid temperature transitions from the elevated wall temperature toward the bulk fluid temperature. Within the thermal boundary layer adjacent to the heated left wall, the elevated fluid temperature causes a corresponding reduction in local viscosity. This reduced viscosity in the boundary layer induces the slip phenomenon that accelerates fluid flow along the heated wall surface and transforms the velocity profile from a symmetric Poiseuille-type distribution toward an asymmetric distribution with higher peak velocities closer to the heated wall.

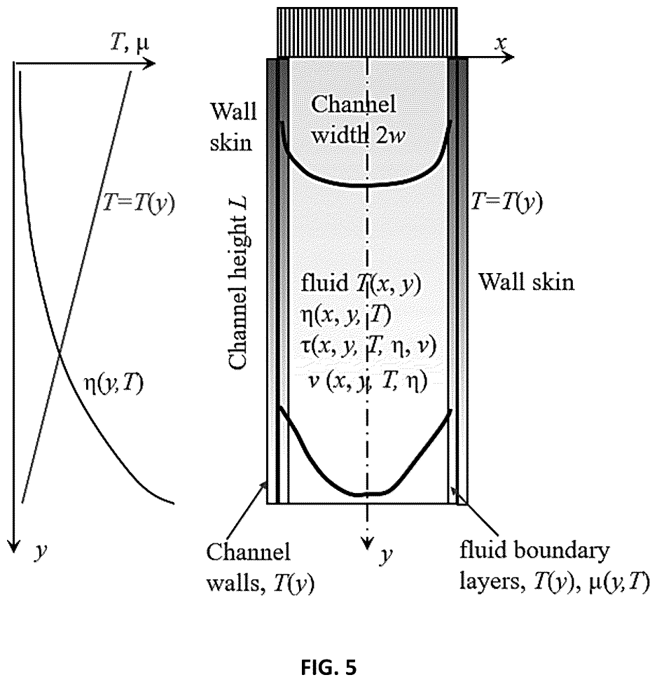

FIG. 5 illustrates a schematic diagram showing the thermal and fluid dynamics within a slot-die channel where wall surface temperature varies as a function of channel height. On the left side of the figure, a graph shows the relationship between temperature T and viscosity η as functions of channel height y. The temperature profile T equals T(y) is represented by a curve, and the viscosity profile η(y, T) is shown as a separate curve demonstrating the temperature-dependent viscosity behavior along the channel height L. The two curves illustrate that as wall surface temperature varies along the channel height, the boundary-layer viscosity varies correspondingly due to the strong temperature dependence of viscosity. Note that in FIG. 4, x starts from the left-side wall, different from that shown in FIGS. 2, 3, 5 and 6.

On the right side of FIG. 5, a cross-sectional view of the slot-die channel is shown with a channel width of 2 w and a channel height L. The channel walls on both the left and right sides are depicted with wall skin regions, each having a temperature distribution T equals T(y) along the height. The y-axis is oriented downward along the channel height, while the x-axis extends horizontally across the channel width. The wall surface temperature variation along the channel height establishes spatially varying thermal boundary conditions for the fluid material flowing through the channel. The fluid boundary layers form adjacent to the channel walls, characterized by temperature T(y) and viscosity μ(y, T). The boundary-layer temperature at any vertical position along the channel height approaches the local wall surface temperature at that position. As previously discussed, because viscosity exhibits a strong dependence on temperature, the boundary-layer viscosity at each vertical position is determined by the local wall surface temperature. When the wall surface temperature is controlled to vary along the channel height, the boundary-layer viscosity varies correspondingly along the channel height. Again, the fluid properties vary as functions of both horizontal position and vertical position. The fluid temperature T(x, y) varies spatially within the channel, influenced by the thermal boundary conditions established by the wall surface temperatures. The fluid viscosity η(x, y, T) depends on both position and the local temperature, with values in the boundary layers determined by the wall surface temperatures and values in the bulk region determined by the bulk fluid temperature. The shear stress τ(x, y, T, η, v) within the fluid material is a function of position, temperature, viscosity, and velocity. The velocity v(x, y, T, η) is a function of position, temperature, and viscosity. As explained above, when the wall surface temperature is controlled as a function of channel height equals T(y), the boundary-layer viscosity becomes a function of channel height η(y, T). This spatially varying boundary-layer viscosity causes the flow velocity profile to change shape as the fluid material travels from the top to the bottom of the channel. At positions along the channel height where the wall surface temperature is higher, the boundary-layer viscosity is lower, inducing greater slip and higher flow velocities near the wall surfaces. At positions along the channel height where the wall surface temperature is lower, the boundary-layer viscosity is higher, resulting in less slip and lower flow velocities near the wall surfaces.

The variation in flow velocity profiles along the channel height produces corresponding variations in shear stress within the fluid material. Different fluid flow profiles result in different shear stresses that may drive re-ordering of fluid components within multi-component fluid materials. The ability to control the evolution of velocity profiles and shear stress distributions along the channel height through wall surface temperature variation provides a mechanism for influencing the processing of fluid materials as the fluid materials pass through the slot-die channel. The resulting exit flow profiles at the channel outlet depend on the cumulative effects of the wall surface temperature variation along the entire channel height. FIG. 5 shows Design 1a of this invention.

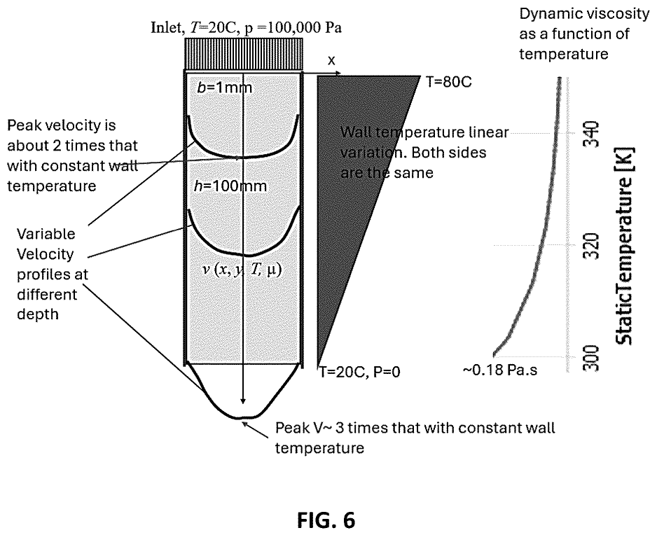

FIG. 6 illustrates an example of FIG. 5; it shows schematic diagram of a slot-die channel configuration where wall surface temperature varies as a gradient along the channel height. The channel has a width of 1 mm and a height of 100 mm. An inlet is positioned at the top of the channel where fluid material enters at a temperature of 20° C. and a pressure of 100,000 Pa. An outlet is positioned at the bottom of the channel at a pressure of zero. Both the left wall surface and the right wall surface have the same temperature variation scale from the top to the bottom of the channel. The wall surface temperature variation is about 80° C. at the inlet to about 20° C. at the outlet. The wall surface temperature is controlled to vary as a gradient along the channel height, where both walls have the same temperature variation scale from top to bottom. This symmetric gradient configuration differs from the constant asymmetric temperature configuration described with reference to FIG. 3, where one wall is maintained at a uniformly higher temperature than the other wall. In the gradient configuration of FIG. 6, the wall surface temperature at any given vertical position is the same for both the left wall and the right wall, but the wall surface temperature deceases progressively along the channel height from the inlet to the outlet.

As further shown in FIG. 6, variable velocity profiles are illustrated at different depths within the channel. The velocity profiles change shape along the channel height as the fluid material flows from the inlet toward the outlet. Near the inlet, the velocity profile exhibits a shape characteristic of flow with relatively lower boundary-layer viscosity due to higher temperature. As the fluid material progresses toward the outlet, the boundary-layer viscosity increases due to the reduced wall surface temperature, and the velocity profile shape changes correspondingly. The velocity is expressed as a function of position, temperature, and viscosity. Annotations in FIG. 6 indicate that the peak velocity at certain locations within the channel is approximately two times that observed with constant wall temperature. Near the outlet the peak velocity is approximately three times that observed with constant wall temperature. The progressive increase in peak velocity along the channel height results from the progressive increase in boundary-layer viscosity caused by the decreasing wall surface temperature gradient. The graph positioned adjacent to the channel shows dynamic viscosity as a function of temperature.

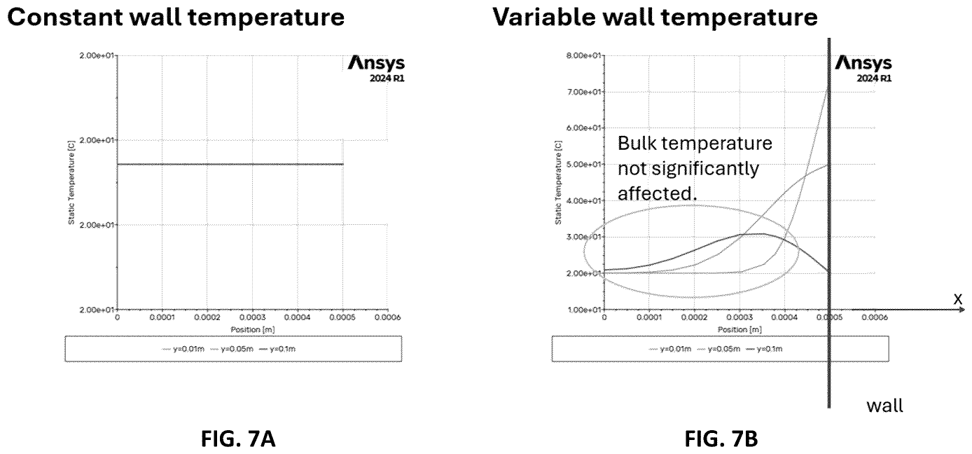

Referring to FIGS. 7A-7B, comparative graphs show cross-sectional temperature profiles within a slot-die coater channel under constant wall temperature conditions and the variable wall temperature conditions shown in FIG. 6, respectively. Both graphs display static temperature in degrees Celsius on the vertical axis and position in meters on the horizontal axis starting at the middle of the channel. Data is plotted for three different vertical positions within the channel: y equals 0.01 m, y equals 0.05 m, and y equals 0.1 m.

FIG. 7A shows the temperature distribution when constant wall temperatures are applied to the channel walls. Under constant wall temperature conditions, the temperature profiles remain flat and uniform across the channel width. All three curves corresponding to the different vertical positions overlap one another regardless of the vertical position within the channel. The flat temperature profiles indicate that no thermal gradients develop across the channel width when both wall surfaces are maintained at the same constant temperature as the bulk fluid temperature. The overlapping curves at the three different vertical positions demonstrate that the temperature distribution does not change along the channel height under constant wall temperature conditions.

FIG. 7B shows the temperature distribution when variable wall temperatures are applied along the channel height. Under variable wall temperature conditions, the temperature profiles exhibit distinct variations compared to the constant temperature case. In the bulk region of the channel away from the wall boundaries, the temperature remains relatively stable at values approaching the fluid inlet temperature. An annotation in FIG. 7B indicates that bulk temperature is not significantly affected by the variable wall temperature conditions. The thermal effects of the heated wall surfaces are confined primarily to the boundary layer regions adjacent to the walls rather than penetrating into the bulk fluid region. The temperature profiles exhibit sharp increases near the wall boundary. At the y equals 0.01 m position near the channel inlet where wall surface temperature is the highest in the variable temperature configuration, the temperature near the wall boundary reaches the highest values compared to positions further downstream. At the y equals 0.05 m position at an intermediate height within the channel, the temperature near the wall boundary reaches intermediate values. At the y equals 0.1 m position near the channel outlet where wall surface temperature is the lowest, the temperature near the wall boundary reaches the highest values approaching 20 degrees Celsius.

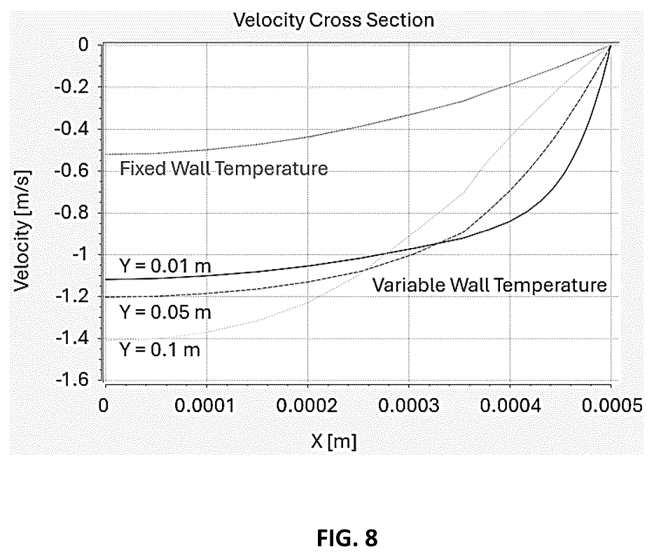

FIG. 8 graphically compares velocity cross-section profiles, with x=0 for the middle of the channel, for fixed wall temperature conditions versus variable wall temperature conditions shown in FIG. 6 at different vertical positions within a slot-die channel. The graph displays four curves corresponding to three different vertical positions (Y equals 0.01 m, Y equals 0.05 m, and Y equals 0.1 m) for each of the two wall temperature conditions. Fixed wall temperature curves are shown in red, while variable wall temperature curves are shown in gray or black. Under fixed wall temperature conditions, the velocity profiles at the three vertical positions are identical to one another. The curves corresponding to Y equals 0.01 m, Y equals 0.05 m, and Y equals 0.1 m substantially overlap throughout the channel width, indicating that the flow behavior remains consistent as the fluid material travels from the inlet region toward the outlet region of the channel. The velocity is greatest at the center of the channel where X is 0 and decreases toward zero as X approaches the wall boundary at 0.0005 m. The overlapping velocity profiles under fixed wall temperature conditions demonstrate that maintaining constant wall surface temperatures along the channel height produces uniform flow characteristics regardless of vertical position within the channel. Under variable wall temperature conditions, the velocity profiles at the three vertical positions exhibit distinct differences from one another. The curves corresponding to Y equals 0.01 m, Y equals 0.05 m, and Y equals 0.1 m are separated rather than overlapping, demonstrating that the velocity profile shape changes as a function of vertical position along the channel height. At the Y equals 0.01 m position near the channel inlet where wall surface temperature is the highest in the variable temperature configuration, the velocity profile close to the wall exhibits sharp velocity increase. At the Y equals 0.05 m position at an intermediate height within the channel, the velocity profile exhibits intermediate velocity magnitudes. At the Y equals 0.1 m position near the channel outlet where wall surface temperature is lower, the velocity profile exhibits the highest velocity magnitudes among the three positions, while the velocity profile near the wall aooroches that of the constant wall-temperature case. The comparison of the fixed and variable wall temperature conditions demonstrates the effect of wall surface temperature control on the evolution of velocity profiles along the channel height. When wall surface temperature is fixed at a constant value along the channel height, the boundary-layer viscosity remains constant, and the velocity profile shape does not change appreciably as the fluid material flows through the channel. When wall surface temperature varies as a function of channel height, the boundary-layer viscosity varies correspondingly, causing the velocity profile shape to evolve continuously along the channel height. The variable wall temperature configuration produces distinct velocity profile changes at different channel heights, with progressively higher velocity magnitudes achieved at positions where wall surface temperatures are reduced and boundary-layer viscosities are correspondingly increased.

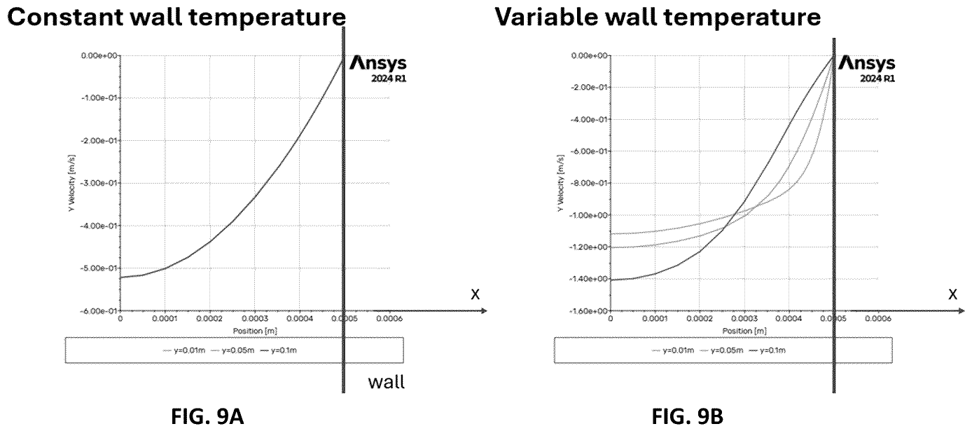

Referring to FIGS. 9A-9B, graphs for the results of FIG. 6, depict Y velocity profiles as a function of position for fluid flow within a slot-die channel under different wall temperature conditions. Both graphs display Y velocity in meters per second on the vertical axis and position in meters on the horizontal axis starting from the middle of the channel. Data is plotted for three different vertical positions within the channel: y equals 0.01 m, y equals 0.05 m, and y equals 0.1 m.

FIG. 9A shows velocity profiles under constant wall temperature conditions. Under constant wall temperature conditions, the three curves corresponding to the different y positions substantially overlap one another. The substantial overlap of the curves indicates that the velocity profiles remain nearly uniform at different heights within the channel when the wall surface temperature is maintained constant along the channel height. The overlapping curves demonstrate that the flow characteristics do not change appreciably as the fluid material travels from the top of the channel toward the bottom of the channel when wall surface temperatures are held constant.

FIG. 9B shows velocity profiles under variable wall temperature conditions. Under variable wall temperature conditions, the three curves corresponding to the different y positions are distinctly separated from one another. The distinct separation of the curves demonstrates that the velocity profiles change shape as the fluid material moves from the top to the bottom of the channel when wall surface temperature varies along the channel height. The separation of the curves in FIG. 9B illustrates how controlling wall surface temperature as a function of channel height affects the boundary-layer viscosity and consequently alters the flow velocity distribution within the slot-die channel. At the y equals 0.01 m position near the inlet where wall surface temperature is higher, the velocity profile exhibits a shape associated with lower boundary-layer viscosity. At the y equals 0.05 m position at an intermediate height within the channel, the velocity profile exhibits a different shape reflecting the intermediate wall surface temperature at that location. At the y equals 0.1 m position near the outlet where wall surface temperature is lower, the velocity profile exhibits yet another shape with higher velocity magnitudes, reflecting the higher boundary-layer viscosity induced by the reduced wall surface temperature and the accumulated effect of wall temperature change.

The comparison between FIG. 9A and FIG. 9B demonstrates the effect of wall surface temperature control on the evolution of velocity profiles along the channel height. When wall surface temperature is constant, the velocity profile shape remains consistent throughout the channel, as evidenced by the overlapping curves in FIG. 9A. When wall surface temperature varies as a function of channel height, the velocity profile shape evolves continuously as the fluid material flows through the channel, as evidenced by the separated curves in FIG. 9B. The variable wall temperature configuration produces velocity profiles that progressively change character along the channel height, with higher velocity magnitudes achieved near the outlet.

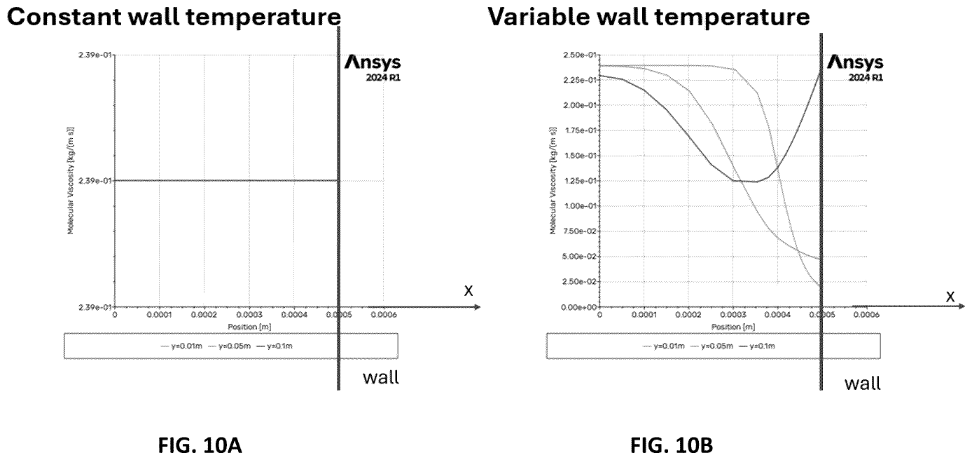

Referring to FIGS. 10A-10B, comparative graphs show molecular viscosity profiles as a function of position across a slot-die channel, with x=0 at the middle of the channel, under two different wall temperature conditions. Both graphs display molecular viscosity in units of kg/(m·s) on the vertical axis and position in meters on the horizontal axis. Data is plotted for three different height locations within the channel: y equals 0.01 m, y equals 0.05 m, and y equals 0.1 m. A vertical line in each graph indicates the wall position.

FIG. 10A shows the viscosity distribution when constant wall temperatures are applied to the channel walls. Under constant wall temperature conditions, the molecular viscosity remains essentially uniform across the entire channel width. The three curves representing the different height locations overlap completely with one another, indicating no variation in viscosity with channel height under constant temperature conditions. The uniform viscosity distribution across the channel width and along the channel height reflects the absence of thermal gradients that would otherwise induce viscosity variations within the fluid material.

FIG. 10B shows the viscosity distribution when variable wall temperatures shown in FIG. 6 are applied along the channel height. Under variable wall temperature conditions, the molecular viscosity varies across the channel width. The three curves corresponding to the different height locations exhibit distinct profiles that differ from one another, demonstrating that the viscosity distribution changes as a function of both position across the channel and height along the channel. Near the wall boundary at approximately 0.0005 m, the viscosity decreases substantially compared to the bulk region of the channel. The viscosity reduction near the wall boundary is particularly pronounced at the y equals 0.1 m location, which corresponds to a position near the channel outlet where the wall surface temperature is lowest in the variable temperature configuration. At the y equals 0.01 m location near the channel inlet where wall surface temperature is higher, the viscosity near the wall boundary is the lowest. At the y equals 0.05 m location at an intermediate height within the channel, the viscosity profile exhibits intermediate characteristics between the inlet and outlet profiles.

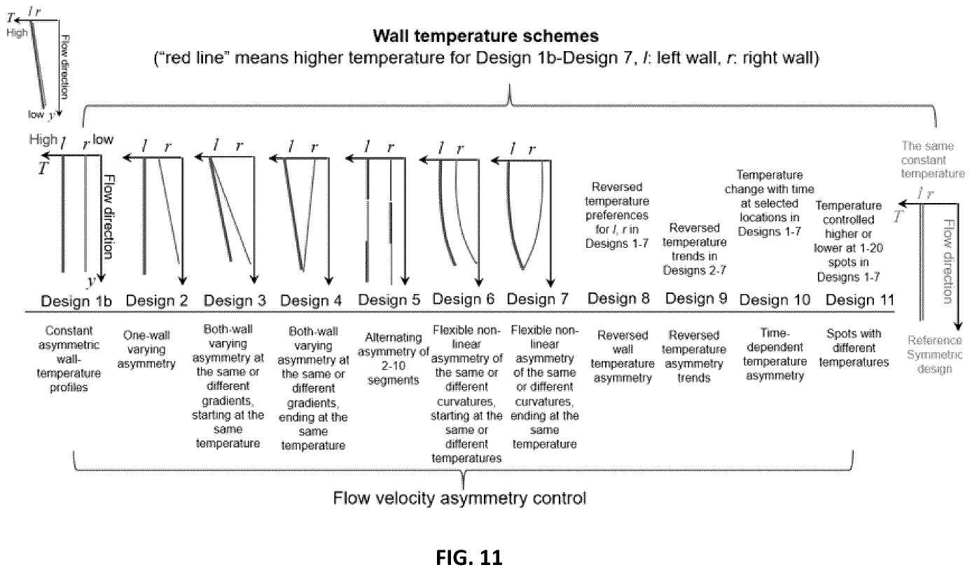

FIG. 11 illustrates various wall temperature schemes for flow temperature and flow velocity asymmetry control in a slot-die coater system. The diagram presents multiple design configurations arranged horizontally, each showing a channel cross-section with left wall and right wall temperature profiles. The flow direction is indicated by arrows pointing downward through the channels, with the vertical axis representing temperature and the horizontal positions marked as l for left wall and r for right wall. Red coloring in the diagram represents higher temperature regions (except in 1a) relative to other regions within each design configuration.

FIG. 11, Design 1a is the case shown in FIG. 6 with both wall temperature change in the same way from high to low linearly or non-linearly. Here the line colors only differentiate between the left and right walls. Design 1b depicts a constant asymmetric wall-temperature profile configuration. In Design 1, one wall maintains a uniformly higher temperature than the other wall along the entire channel height from the inlet to the outlet. The temperature at each wall remains constant along the channel height, but the temperature at the right wall is higher than the temperature at the left wall. This constant asymmetric configuration produces an asymmetric thermal environment that remains unchanged as the fluid material flows through the channel, resulting in velocity profiles that maintain a consistent asymmetric shape along the channel height.

FIG. 11, Design 2 depicts a one-wall varying asymmetry configuration. In Design 2, one wall has a temperature gradient along the flow direction while the other wall maintains a constant temperature. The temperature variation occurs along the channel height from the inlet to the outlet on one wall surface, from high to low, while the opposing wall surface remains at a uniform temperature. This configuration produces an asymmetric thermal environment where the degree of asymmetry changes along the channel height as the fluid material flows from the inlet toward the outlet.

FIG. 11, Design 3 depicts a both-wall varying asymmetry configuration where both walls have temperature gradients starting at the same temperature. In Design 3, both the left wall and the right wall exhibit temperature variations along the channel height, with both walls beginning at the same temperature at the inlet. The temperature gradients on the two walls may be the same or different from one another. When the gradients differ, the temperature differential between the two walls changes along the channel height, producing an asymmetric thermal environment that evolves as the fluid material flows through the channel.

FIG. 11, Design 4 depicts a both-wall varying asymmetry configuration where both walls have temperature gradients ending at the same temperature. In Design 4, both the left wall and the right wall exhibit temperature variations along the channel height, with both walls reaching the same temperature at the outlet. The temperature gradients on the two walls may be the same or different from one another. This configuration produces an asymmetric thermal environment along the channel height that converges toward a symmetric condition at the channel outlet.

FIG. 11, Design 5 depicts an alternating asymmetry configuration with multiple segments along the channel depth. The temperature asymmetry between the left wall and the right wall alternates direction along the channel height. The channel height may be divided into 2 to 10 segments, with the wall having the higher temperature alternating between the left wall and the right wall from one segment to the next. This alternating configuration produces periodic reversals in the asymmetric thermal environment as the fluid material flows through the channel, resulting in corresponding periodic changes in the velocity profile asymmetry.

FIG. 11, Design 6 depicts configurations where the temperature profiles on the left wall and the right wall may have the same or different curvatures, and the profiles may start at the same or different temperatures at the inlet. This design also includes linear variation (curvature=0) at the same slope. Non-linear temperature profiles provide additional flexibility in controlling the evolution of the thermal environment and the corresponding velocity profiles along the channel height compared to linear gradient configurations

FIG. 11, Design 7 depicts the temperature profiles on the left wall and the right wall may have the same or different curvature values, but opposite in direction, with both profiles converging to the same temperature value at the channel outlet. This configuration produces a non-linear evolution of the asymmetric thermal environment that converges toward a symmetric condition at the channel exit

FIG. 11, Design 8 reverses the wall temperature asymmetry from Designs 1-7.

FIG. 11, Design 9 reverses temperature asymmetry rends of Designs 2-7.

FIG. 11, Design 10 depicts a time-dependent temperature asymmetry configuration in which the surface temperature changes with time at selected locations within the channel. The selected locations may include points, lines, areas, or the entire surface of one or both channel wall surfaces. The time-dependent temperature control may be applied to any of the spatial temperature configurations described in Designs 1 through 9. Time-dependent temperature control provides the capability to dynamically adjust the thermal environment within the channel during the coating process, enabling real-time modification of the velocity profiles and flow characteristics in response to process conditions or quality control requirements.

FIG. 11, Design 11 illustrates a spot temperature control configuration in which discrete spots on the channel wall surfaces are controlled to temperatures that are higher or lower than the surrounding wall surface regions. The number of controlled spots may range from one to twenty or more spots distributed along the channel wall surfaces. The spot temperature control may be applied in combination with any of the spatial temperature configurations described in Designs 1 through 9. Localized temperature control at discrete spots provides the capability to create localized variations in the thermal boundary layer and corresponding localized modifications to the velocity profile at specific positions along the channel height.

The reference symmetric design shown in FIG. 11 depicts a baseline configuration where both walls are maintained at the same constant temperature along the entire channel height. The symmetric design provides a comparison baseline for evaluating the effects of the asymmetric temperature configurations described in Designs 1 through 11.

As described above, the transformation of the velocity profile from Poiseuille-type toward Couette-type reduces the change in shear rate across the channel width. In Poiseuille flow, the shear rate varies from a maximum value at the wall surfaces to zero at the channel centerline, representing a large change in shear rate across the channel width. As the velocity profile transforms toward Couette-type flow due to the slip induced by wall surface temperature control, the shear rate distribution becomes more uniform across the channel width. The reduced variation in shear rate across the channel provides a more spatially uniform shear environment for the fluid material as the fluid material flows through the channel.

The more spatially uniform shear rate within the channel provides advantages for processing fluid materials that are sensitive to shear conditions. When shear rate varies across the channel width as in Poiseuille flow, different portions of the fluid material experience different shear histories as the fluid material passes through the channel. Fluid material near the wall surfaces experiences high shear rates while fluid material near the channel centerline experiences low shear rates. The non-uniform shear history may produce non-uniform processing effects within the fluid material. When the shear rate distribution is more uniform as in the transformed flow field approaching Couette-type flow, the fluid material experiences a more consistent shear history across the channel width, promoting more uniform processing of the fluid material.

The slip induced by wall surface temperature control also reduces the potential for recirculation at the channel exit. When fluid material exits the slot-die channel and encounters the moving boundary of the substrate, the fluid material undergoes a transition from the confined channel flow to the coating flow on the substrate surface. In Poiseuille flow where the fluid velocity at the wall surface is zero, the fluid material near the channel walls experiences a large velocity change when encountering the moving substrate, which may induce recirculation zones at the channel exit. Recirculation zones may trap fluid material and cause non-uniformities in the deposited coating.

The temperature ranges employed for wall surface temperature control may depend on the type of fluid material being processed through the slot-die channel. Different fluid materials exhibit different thermal characteristics, including different temperature sensitivities of viscosity, different thermal stability limits, and different processing temperature requirements. The selection of appropriate temperature ranges for wall surface temperature control accounts for these material-specific characteristics to achieve the desired flow field transformation while maintaining the integrity and processability of the fluid material. For fluid materials comprising polymers or polymer-based materials, the temperature range for wall surface temperature control may be between 20° C. to 300° C. Polymer-based fluid materials include polymer solutions, polymer melts, polymer suspensions, and composite materials containing polymers as a matrix or binder component. The lower end of the temperature range at 20° C. corresponds to ambient or near-ambient conditions where many polymer-based fluid materials are processed. The upper end of the temperature range at 300° C. accommodates polymer materials that require elevated processing temperatures, such as high-temperature engineering polymers or polymer melts that exhibit suitable flow characteristics at elevated temperatures.

Within the 20° C. to 300° C. temperature range for polymer-based fluid materials, the specific wall surface temperatures selected for a given application depend on the thermal properties of the particular polymer or polymer-based composition being processed. Polymers exhibit glass transition temperatures, melting temperatures, and thermal degradation temperatures that define the processing window within which the polymer material maintains suitable properties. Wall surface temperatures may be selected to remain below thermal degradation temperatures while achieving sufficient viscosity reduction in the thermal boundary layer to induce the desired slip effect. The temperature differential between the wall surface and the bulk fluid may be adjusted within the 20° C. to 300° C. range to achieve the desired degree of flow field transformation for the specific polymer-based fluid material.

For fluid materials comprising metal-based materials, the temperature range for wall surface temperature control may be between 20° C. to 500° C. Metal-based fluid materials include molten metals, metal alloys in liquid form, metal suspensions, and composite materials containing liquid metals as a component. The extended upper temperature limit of 500° C. for liquid metal-based materials compared to the 300° C. upper limit for polymer-based materials reflects the higher processing temperatures associated with metallic materials. Many metals and metal alloys remain in liquid form at temperatures well above 300° C., and processing of liquid metal-based fluid materials may require wall surface temperatures approaching or exceeding 500° C. to achieve the desired viscosity reduction in the thermal boundary layer.

The slot-die coating systems and methods described herein may process a variety of fluid materials having different compositions and physical characteristics. The materials to be processed may include liquid-liquid mixtures, where two or more liquid components are combined to form a fluid material that flows through the slot-die channel. Liquid-liquid mixtures may include immiscible liquid phases that form emulsions or dispersions, miscible liquid phases that form homogeneous solutions, or partially miscible liquid phases that exhibit phase separation behavior depending on temperature and composition. The wall surface temperature control affects the viscosity of the liquid-liquid mixture within the thermal boundary layer, modifying the flow characteristics of the mixture as the mixture passes through the channel.

The materials to be processed may include liquid-solid particle mixtures containing particles suspended or dispersed within a liquid carrier. The particles within liquid-solid particle mixtures may comprise any materials, including metallic particles, ceramic particles, polymeric particles, carbon-based particles, oxide particles, and composite particles containing multiple material phases. The particles may have any shapes, including spherical particles, elongated particles, platelet-shaped particles, fibrous particles, irregular particles, and particles with engineered geometries. The particles may have any sizes, ranging from nanometer-scale particles to micrometer-scale particles to larger particles, with particle size distributions that may be narrow or broad depending on the application requirements. The particles may have any densities, including particles with densities greater than the liquid carrier, particles with densities less than the liquid carrier, and particles with densities approximately equal to the liquid carrier. The wall surface temperature control affects the viscosity of the liquid carrier within the thermal boundary layer, which in turn influences the flow behavior of the suspended particles and the overall rheological characteristics of the liquid-solid particle mixture.

The materials to be processed may include polymer-based composites containing a polymer matrix with dispersed filler materials. Polymer-based composites may include polymers filled with inorganic particles, polymers filled with organic particles, polymers reinforced with fibers, and polymers containing functional additives. The polymer matrix may comprise thermoplastic polymers, thermoset polymers, elastomeric polymers, or combinations thereof. The filler materials may provide mechanical reinforcement, electrical conductivity, thermal conductivity, magnetic properties, optical properties, or other functional characteristics to the composite material. The wall surface temperature control affects the viscosity of the polymer matrix within the thermal boundary layer, modifying the flow behavior of the polymer-based composite and influencing the distribution and orientation of filler materials within the deposited coating.

The materials to be processed may include polymer mixtures containing two or more polymer components blended together. Polymer mixtures may include miscible polymer blends that form homogeneous single-phase materials, immiscible polymer blends that form multi-phase materials with distinct polymer domains, and partially miscible polymer blends that exhibit phase behavior depending on temperature and composition. The polymer components within polymer mixtures may have different molecular weights, different chemical compositions, different architectures, or different functional groups. The wall surface temperature control affects the viscosity of the polymer mixture within the thermal boundary layer, and the temperature-dependent viscosity behavior may differ among the polymer components, influencing the flow characteristics and phase behavior of the polymer mixture as the mixture passes through the channel.

The materials to be processed may include polymer melts and solutions of small molecules or oligomers. Polymer melts comprise polymers heated above their melting temperature or glass transition temperature to achieve a flowable liquid state without the presence of a solvent. Solutions of small molecules or oligomers comprise low molecular weight compounds dissolved in a solvent carrier, where the small molecules or oligomers may include monomers, dimers, trimers, or other low molecular weight species. The wall surface temperature control affects the viscosity of polymer melts and solutions within the thermal boundary layer, with polymer melts exhibiting temperature-dependent viscosity behavior governed by the polymer molecular weight and chain architecture, and solutions exhibiting temperature-dependent viscosity behavior governed by the concentration and molecular characteristics of the dissolved species.

The slot-die coating systems and methods described herein may process slurry compositions containing particles of functional materials combined with binder components and solvent carriers. Slurry compositions provide a flowable medium for depositing solid particles onto substrates, where the binder component promotes adhesion of the particles to the substrate and cohesion among the particles within the deposited coating, and the solvent carrier provides the liquid phase that enables flow through the slot-die channel. The wall surface temperature control affects the viscosity of the slurry within the thermal boundary layer, modifying the flow characteristics of the slurry and influencing the distribution of particles and binder within the deposited coating. Slurry compositions processed through the slot-die coating system may contain binder materials selected to provide adhesion, mechanical integrity, and processing characteristics suitable for the intended application. In some examples, a slurry may contain polyvinylidene fluoride (PVDF) as a binder component. PVDF is a fluoropolymer that provides chemical resistance, electrochemical stability, and adhesion properties suitable for battery electrode applications and other electrochemical device coatings. In some examples, a slurry may contain polytetrafluoroethylene (PTFE) as a binder component. PTFE is a fluoropolymer that provides low friction characteristics, chemical inertness, and thermal stability.

In some examples, a slurry may contain styrene-butadiene rubber (SBR) as a binder component. SBR is an elastomeric copolymer that provides flexibility, adhesion, and mechanical resilience to deposited coatings. In some examples, a slurry may contain chitosan as a binder component. Chitosan is a biopolymer derived from chitin that provides biodegradability, biocompatibility, and film-forming characteristics. In some examples, a slurry may contain lignin as a binder component. Lignin is a natural polymer derived from plant materials that provides renewable sourcing and carbon-rich composition.

In some examples, a slurry may contain polyacrylic acid (PAA) as a binder component. PAA is a water-soluble polymer that provides adhesion, film-forming properties, and compatibility with aqueous processing systems. In some examples, a slurry may contain sodium alginate (SA) as a binder component. Sodium alginate is a polysaccharide derived from seaweed that provides gel-forming characteristics, water solubility, and biocompatibility. In some examples, a slurry may contain carboxymethyl cellulose (CMC) as a binder component. CMC is a cellulose derivative that provides thickening, stabilization, and film-forming properties in aqueous slurry systems. Slurry compositions may contain a single binder component or combinations of multiple binder components to achieve desired processing and performance characteristics.

Slurry compositions processed through the slot-die coating system may contain solvent carriers selected to dissolve or disperse the binder component and provide suitable flow characteristics for the coating process. In some examples, a slurry may contain water as a solvent carrier. Water provides an environmentally benign, low-cost solvent option compatible with water-soluble binders such as CMC, PAA, sodium alginate, and SBR dispersions. In some examples, a slurry may contain N,N-dimethylformamide (DMF) as a solvent carrier. DMF is an aprotic solvent that dissolves a range of polymer binders and provides suitable viscosity characteristics for coating applications.

In some examples, a slurry may contain N-methyl-2-pyrrolidone (NMP) as a solvent carrier. NMP is a polar aprotic solvent that dissolves PVDF and other fluoropolymer binders, providing processing characteristics suitable for battery electrode coating applications. In some examples, a slurry may contain p-xylene as a solvent carrier. p-Xylene is an aromatic hydrocarbon solvent that dissolves certain polymer binders and provides volatility characteristics suitable for rapid drying of deposited coatings. In some examples, a slurry may contain ethanol as a solvent carrier. Ethanol is a polar protic solvent that provides low toxicity, rapid evaporation, and compatibility with certain binder systems.

In some examples, a slurry may contain toluene as a solvent carrier. Toluene is an aromatic hydrocarbon solvent that dissolves a range of polymer binders and provides processing characteristics suitable for various coating applications. In some examples, a slurry may contain Cyrene as a solvent carrier. Cyrene is a bio-derived dipolar aprotic solvent that provides an alternative to petroleum-derived solvents such as NMP, offering reduced environmental impact while maintaining dissolution characteristics for polymer binders. Slurry compositions may contain a single solvent or combinations of multiple solvents to achieve desired dissolution, viscosity, and drying characteristics for the coating process.

The coating bed within the slot-die coating system may hold a functional substrate onto which the fluid material is deposited to form a coating. The functional substrate provides a support structure that becomes part of the final coated product, with the deposited coating adhering to and remaining on the functional substrate during subsequent processing and end use. The selection of functional substrate material depends on the intended application of the coated product and the compatibility requirements between the substrate material and the deposited coating. In some examples, the coating bed may hold a metallic functional substrate. Metallic substrates provide electrical conductivity, mechanical strength, and thermal conductivity characteristics suitable for various coating applications. In other examples, the metallic functional substrate may comprise copper. Copper substrates provide high electrical conductivity and are employed in applications such as battery electrode current collectors where electrical conduction between the deposited coating and external circuitry is desired. In some examples, the metallic functional substrate may comprise aluminum. Aluminum substrates provide electrical conductivity combined with lower density compared to copper and are employed in applications such as battery electrode current collectors and other electrochemical device components.

In some examples, the coating bed may hold a plastic functional substrate. Plastic substrates provide flexibility, low weight, and electrical insulation characteristics suitable for various coating applications. In certain examples, the plastic functional substrate may comprise polyethylene terephthalate (PET). PET substrates provide mechanical strength, dimensional stability, optical clarity, and chemical resistance, and are employed in applications such as flexible electronics, display components, and packaging materials where a flexible polymeric support structure is desired beneath the deposited coating.

In some examples, the coating bed may hold a fuel cell membrane as a functional substrate. Fuel cell membranes comprise ion-conducting polymer materials that facilitate electrochemical reactions within fuel cell devices. The deposition of coatings onto fuel cell membranes may provide catalyst layers, electrode layers, or protective layers that enhance the performance or durability of the fuel cell membrane assembly. The wall surface temperature control within the slot-die channel may be adjusted to accommodate the thermal sensitivity of fuel cell membrane materials during the coating deposition process.

In some examples, the coating bed may hold a textile functional substrate. Textile substrates comprise woven, knitted, or nonwoven fabric materials that provide flexibility, porosity, and conformability characteristics. The deposition of coatings onto textile substrates may provide functional properties such as electrical conductivity, sensing capability, protective characteristics, or aesthetic features to the textile material. The porous structure of textile substrates may influence the penetration and adhesion of the deposited coating, and the wall surface temperature control within the slot-die channel may be adjusted to achieve desired coating characteristics on textile substrates.

In some examples, the coating bed may hold a removable sheet rather than a functional substrate that becomes part of the final product. The removable sheet provides a temporary support surface onto which the fluid material is deposited to form a thin film. After deposition and any subsequent processing such as drying or curing, the thin film material may be separated from the removable sheet to obtain a free-standing thin film without a functional substrate attached. The removable sheet may comprise materials selected to provide suitable release characteristics that enable separation of the deposited thin film without damage to the thin film structure. The removable sheet configuration enables production of free-standing thin films, membranes, or coatings that are employed in applications where the presence of a substrate would be undesirable or where the thin film material is subsequently transferred to a different substrate or incorporated into a device structure. The wall surface temperature control within the slot-die channel may be adjusted to achieve thin film characteristics suitable for separation from the removable sheet, including mechanical integrity, uniformity, and surface properties that facilitate the release process.

The wall surface temperature within the slot-die channel may be controlled via a feedback control system. The feedback control system monitors parameters associated with the coating process and adjusts the wall surface temperatures in response to the monitored parameters. The feedback control system may request temperature changes based on quality control parameters, process control parameters, or combinations thereof. Quality control parameters may include coating thickness, coating uniformity, surface roughness, defect density, coating weight, and other characteristics of the deposited coating that indicate whether the coating meets specified quality requirements. Process control parameters may include flow rate, pressure, temperature, viscosity, and other characteristics of the fluid material and the coating process that indicate whether the process is operating within specified conditions. The feedback control system may include sensors configured to measure quality control parameters or process control parameters during the coating operation. Sensors may include thickness gauges, optical sensors, temperature sensors, pressure sensors, flow sensors, viscosity sensors, and other measurement devices positioned to monitor relevant parameters. The sensors may be positioned upstream of the slot-die channel to monitor incoming fluid material characteristics, within the slot-die channel to monitor conditions during fluid flow through the channel, downstream of the slot-die channel to monitor the deposited coating characteristics, or at multiple positions to provide comprehensive process monitoring.

The feedback control system may include a controller configured to receive sensor signals, compare the measured parameters to target values or acceptable ranges, and generate control signals to adjust the wall surface temperatures. The controller may implement control algorithms such as proportional-integral-derivative (PID) control, model predictive control, adaptive control, or other control strategies suitable for maintaining the wall surface temperatures at values that achieve desired coating quality and process performance. The controller may adjust the temperature of one wall surface, both wall surfaces, or selected regions of the wall surfaces in response to the feedback signals. The feedback control system may adjust wall surface temperatures in response to detected variations in coating quality. When sensors detect that coating thickness deviates from a target value, the feedback control system may adjust wall surface temperatures to modify the flow velocity profile and thereby adjust the coating thickness toward the target value. When sensors detect non-uniformities in the deposited coating, the feedback control system may adjust wall surface temperatures to modify the shear rate distribution within the channel and thereby improve coating uniformity. When sensors detect defects in the deposited coating, the feedback control system may adjust wall surface temperatures to modify the flow characteristics and thereby reduce defect formation.

The feedback control system may adjust wall surface temperatures in response to detected variations in process conditions. When sensors detect that fluid material viscosity has changed due to temperature variations, composition variations, or other factors, the feedback control system may adjust wall surface temperatures to compensate for the viscosity change and maintain consistent flow characteristics. When sensors detect that flow rate has deviated from a target value, the feedback control system may adjust wall surface temperatures to modify the slip effect and thereby adjust the flow rate toward the target value. When sensors detect that pressure within the channel has changed, the feedback control system may adjust wall surface temperatures to modify the flow resistance and thereby maintain desired pressure conditions. The feedback control system enables real-time adjustment of the wall surface temperature profiles during the coating operation. Rather than maintaining fixed wall surface temperatures throughout the coating process, the feedback control system may dynamically modify the temperatures in response to changing conditions or requirements. Dynamic temperature adjustment may compensate for variations in incoming fluid material properties, variations in substrate characteristics, variations in environmental conditions, or other factors that influence the coating process. Dynamic temperature adjustment may also enable production of coatings with intentionally varying characteristics along the coating length, where the wall surface temperatures are adjusted according to a programmed profile to produce corresponding variations in the deposited coating.

The slot-die coating system may be configured with various movement arrangements between the slot-die coater and the coating bed. In some examples, the coating bed may be movable while the slot-die coater remains stationary. The movable coating bed travels at a layering velocity beneath the stationary slot-die coater, and the fluid material discharged from the slot-die channel is deposited onto the moving substrate carried by the coating bed. The relative motion between the stationary slot-die coater and the moving coating bed determines the coating deposition rate and the coating thickness for a given volumetric flow rate of fluid material through the slot-die channel. In some examples, the slot-die coater may be movable while the coating bed remains stationary. The movable slot-die coater travels at a layering velocity above the stationary coating bed, and the fluid material discharged from the slot-die channel is deposited onto the substrate held by the stationary coating bed. The relative motion between the moving slot-die coater and the stationary coating bed determines the coating deposition rate and the coating thickness for a given volumetric flow rate of fluid material through the slot-die channel. The movable slot-die coater configuration may be employed in applications where moving the substrate is impractical or undesirable, such as when coating large or heavy substrates. In other examples, both the slot-die coater and the coating bed may be movable. The slot-die coater and the coating bed may move in the same direction at different velocities, in opposite directions, or in perpendicular directions depending on the coating pattern and coverage requirements. The relative velocity between the slot-die coater and the coating bed determines the effective layering velocity that governs the coating deposition rate and thickness. Configurations with both the slot-die coater and the coating bed movable provide flexibility in achieving desired coating patterns, accommodating different substrate sizes and shapes, and optimizing the coating process for specific applications.

The methods and systems disclosed herein may be used to produce thin films and coatings for lithium-ion battery electrodes. Lithium-ion battery electrodes comprise active material particles that store and release lithium ions during charge and discharge cycles, combined with conductive additives that provide electrical pathways and binder materials that maintain mechanical integrity of the electrode structure. The wall surface-temperature-controlled slot-die coating system may be applied to produce thin films and coatings for lithium-ion battery electrolytes. Solid-state electrolytes and gel electrolytes for lithium-ion batteries may be deposited as thin film coatings using slot-die coating processes. Electrolyte coatings provide ion-conducting pathways between the anode and cathode of the battery while preventing direct electronic contact between the electrodes. The wall surface temperature control within the slot-die channel may be adjusted to achieve flow characteristics suitable for depositing uniform electrolyte coatings with controlled thickness and porosity. The wall surface-temperature-controlled slot-die coating system and related method may be applied to produce thin films and coatings for other battery types beyond lithium-ion batteries such as sodium-ion batteries, potassium-ion batteries, lithium-sulfur batteries, lithium-air batteries, solid-state batteries, and flow batteries employ electrode and electrolyte coatings that may be deposited using slot-die coating processes.

The wall surface-temperature-controlled slot-die coating system may be applied to produce thin films and coatings for sensors. Sensor devices employ functional coatings that respond to physical, chemical, or biological stimuli by producing measurable signals. Sensor coatings may comprise conductive materials, semiconducting materials, piezoelectric materials, electrochemically active materials, or materials that undergo property changes in response to target analytes. The wall surface temperature control within the slot-die channel may be adjusted to achieve flow characteristics that produce sensor coatings with controlled thickness, uniformity, and microstructure. The shear conditions within the slot-die channel, modified through wall surface temperature control, may influence the orientation and distribution of functional components within the sensor coating, affecting the sensitivity and response characteristics of the resulting sensor device.

The wall surface-temperature-controlled slot-die coating system may be applied to produce thin films and coatings for fuel cells. Fuel cell devices convert chemical energy directly into electrical energy through electrochemical reactions occurring at electrode surfaces. Fuel cell electrodes comprise catalyst materials, typically platinum or platinum-group metals, supported on conductive substrates and combined with ion-conducting polymer binders. The catalyst layers are deposited as thin film coatings onto gas diffusion layers or directly onto ion-exchange membranes.

The wall surface-temperature-controlled slot-die coating system may be applied to produce thin films and coatings for electrolyzers. Electrolyzer devices use electrical energy to drive electrochemical reactions that produce chemical products, such as hydrogen production through water electrolysis. Electrolyzer electrodes comprise catalyst materials and conductive supports similar to fuel cell electrodes, with material compositions optimized for the specific electrochemical reactions occurring in the electrolyzer.

The wall surface-temperature-controlled slot-die coating system may be applied to produce thin films and coatings for other electrochemical devices. Electrochemical devices beyond batteries, fuel cells, and electrolyzers include supercapacitors, electrochromic devices, electrochemical sensors, and electrosynthesis reactors.

The wall surface-temperature-controlled slot-die coating system may be applied to produce polymer films and coatings for general use. Polymer films, coatings, and membranes serve diverse functions including protective barriers, optical layers, adhesive layers, release layers, and functional coatings with specific mechanical, thermal, electrical, or chemical properties. Polymer compositions processed through the slot-die coating system may comprise single polymers, mixtures of multiple polymers, or polymer-filler composites containing inorganic or organic filler materials dispersed within a polymer matrix. The wall surface temperature control within the slot-die channel modifies the flow characteristics of polymer compositions, influencing the molecular orientation, chain conformation, and filler distribution within the deposited polymer film or coating.

A number of implementations have been described. Nevertheless, it will be understood that various modifications may be made without departing from the spirit and scope of the disclosure. Accordingly, other implementations are within the scope of the following claims.

1. A slot-die coating system, comprising:
a slot-die head having a channel defined by a first wall and a second wall, the channel configured to receive a fluid material at an inlet and discharge the fluid material at an outlet;
a temperature control system configured to maintain the first wall at a first temperature and the second wall at a second temperature different from the first temperature, wherein a temperature differential between the first wall and the second wall or wherein a first temperature rate variation along the first wall differs from a second temperature rate variation along the second wall induces a viscosity differential in boundary layers of the fluid material adjacent to the first wall and the second wall; and
a coating bed positioned to receive the fluid material discharged from the outlet of the channel.

2. The slot-die coating system of claim 1, wherein the first temperature is higher than the second temperature, and wherein the higher first temperature induces a lower viscosity in the boundary layer of the fluid material adjacent to the first wall relative to the boundary layer adjacent to the second wall.

3. The slot-die coating system of claim 2, wherein the lower viscosity in the boundary layer adjacent to the first wall induces a slip of the fluid material along the first wall, resulting in acceleration of fluid flow along the first wall relative to fluid outside of a thermal boundary layer.

4. The slot-die coating system of claim 3, wherein the slip transforms a flow field of the fluid material from a Poiseuille-type flow profile to a Couette-type flow profile, reducing a change in shear rate across the channel.

5. The slot-die coating system of claim 1, wherein the first temperature and the second temperature are each constant along a height of the channel from the inlet to the outlet.

6. The slot-die coating system of claim 1, wherein the temperature control system is configured to vary the first temperature as a function of position along a height of the channel from the inlet to the outlet.

7. The slot-die coating system of claim 6, wherein the temperature control system is configured to vary the second temperature as a function of position along the height of the channel, and wherein the first temperature and the second temperature vary at a same gradient or at different gradients along the height of the channel.

8. The slot-die coating system of claim 1, wherein the first temperature and the second temperature are within a range of 20°C. to 300°C. for fluid materials comprising polymers or polymer-based materials.

9. The slot-die coating system of claim 1, wherein the first temperature and the second temperature are within a range of 20°C. to 500°C. for fluid materials comprising metal-based materials.

10. The slot-die coating system of claim 1, wherein the coating bed is configured to move at a layering velocity relative to the slot-die head, and wherein the coating bed holds a substrate selected from the group consisting of metals, plastics, fuel cell membranes, and textiles.

11. The slot-die coating system of claim 1, further comprising a feedback control system configured to adjust the first temperature and the second temperature based on quality control or process control parameters.

12. A method for depositing a thin-film coating, comprising:
feeding a fluid material into a channel of a slot-die head, the channel comprising a first wall and a second wall;
controlling a surface temperature of at least one of the first wall and the second wall to create a temperature variation along a height of the channel, wherein the temperature variation induces a change in viscosity of a boundary layer of the fluid material adjacent to the at least one of the first wall and the second wall; and
discharging the fluid material from an outlet of the channel onto a substrate.

13. The method of claim 12, wherein controlling the surface temperature comprises maintaining the first wall at a first temperature higher than a second temperature of the second wall, wherein the higher first temperature induces a lower viscosity in the boundary layer adjacent to the first wall, causing a slip of the fluid material along the first wall.

14. The method of claim 13, wherein the slip transforms a flow field of the fluid material from a Poiseuille-type flow profile to a Couette-type flow profile, providing a more spatially uniform shear rate within the channel.

15. The method of claim 12, wherein the temperature variation comprises a linear temperature gradient along the height of the channel from an inlet to the outlet.

16. The method of claim 12, wherein the fluid material comprises a slurry containing polyvinylidene fluoride, polytetrafluoroethylene, styrene-butadiene rubber, chitosan, lignin, polyacrylic acid, sodium alginate, or carboxymethyl cellulose.

17. A slot-die head for thin-film coating, comprising:
a first channel plate having a first inner surface;
a second channel plate having a second inner surface, the first inner surface and the second inner surface defining a channel therebetween for fluid flow; and
a heating element configured to heat at least one of the first inner surface and the second inner surface to a temperature higher than a temperature of a fluid material within the channel, wherein heating the at least one of the first inner surface and the second inner surface reduces a viscosity of a boundary layer of the fluid material adjacent thereto.

18. The slot-die head of claim 17, wherein the heating element is configured to heat the first inner surface to a first temperature and the second inner surface to a second temperature different from the first temperature, creating an asymmetric temperature distribution across the channel.

19. The slot-die head of claim 18, wherein the reduced viscosity of the boundary layer adjacent to the at least one of the first inner surface and the second inner surface induces a slip of the fluid material, transforming a flow field from a Poiseuille-type flow profile to a Couette-type flow profile.

20. The slot-die head of claim 17, wherein the heating element is configured to vary a temperature of the at least one of the first inner surface and the second inner surface as a function of position along a height of the channel from an inlet to an outlet of the channel.
